(19) United States
(12) Patent Application Publication
(10) Pub. No.: US 2021/0286744 A1
(43) Pub. Date: Sep. 16, 2021

(54) PROGRAMMABLE INPUT/OUTPUT PORT

(71) Applicant: HEWLETT PACKARD ENTERPRISE DEVELOPMENT LP, Houston, TX (US)

(72) Inventors: John Norton, Houston, TX (US); Ku-Hsu Nien, Taipei (TW); Vincent Nguyen, Houston, TX (US); Kuan-WeI Chen, Taipei (TW)

(21) Appl. No.: 16/820,497

(22) Filed: Mar. 16, 2020

(51) Int. Cl. G06F 13/20; G06F 13/42

(52) U.S. Cl. CPC G06F 13/20; G06F 2213/0026; G06F 13/4282

(57) ABSTRACT

A system manages communication between a host device and an end device. The system includes a programmable input/output (I/O) port associated with the host device. The host device is connectable through the programmable I/O port and a cable to a plurality of different types of end devices that are respectively associated with different types of protocols. The system further includes a port manager to detect a signal from an end device interface associated with the end device and determine a type of the end device based on the detected signal. The port manager directs the programmable I/O port to present signals that correspond to a protocol associated with the determined type of the end device to allow the host device to communicate with the end device.

### BACKGROUND

Computing systems may be configurable to provide for communication between a host device and a desired number of end devices. Such configuration typically occurs at the device level.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a perspective view of an assembly including host devices and end device interfaces according to one or more examples.

FIG. 2 illustrates a pinout of a cable from a point of view of a programmable I/O port according to one or more examples.

FIG. 3 conceptually illustrates a system for managing communication between a host device and an end device via a Peripheral Component Interconnect Express (“PCIe”) slot according to one or more examples.

FIG. 4A conceptually illustrates a system for managing communication between a host device and an end device via an Open Compute Project (“OCP”) Network Interface Card (“NIC”) slot according to one or more examples.

FIG. 4B conceptually illustrates a system for managing communication between a host device and an end device via respective OCP NIC slots according to one or more examples.

FIG. 5 conceptually illustrates a system for managing communication between a host device and an end device via a Non-volatile Memory Express Backplane (NVMe BP) according to one or more examples.

FIGS. 6A-6C conceptually illustrate systems for managing communication between a host device and one or more respective end devices via interconnect processor links according to one or more examples.

FIG. 7 is a flowchart depicting a method for managing communication between a host device and an end device according to one or more examples.

FIG. 8 conceptually illustrates a computing device with which the port managers shown in FIGS. 3-6C may be implemented, according to one or more examples.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Many computing systems include a host device that communicates with different types of end devices using different respective communications protocols. As used herein, the term “host device” refers without limitation to a computing device including a processing unit. Examples of a host device may be a central processing unit, a server, a blade server, or any other device or equipment including a controller, a processing resource, or the like. The term “end device” refers without limitation to any device adapted to communicate with a host device including a processing unit. Examples of end devices include, without limitation, memory modules, hard drive or solid-state drives, network connection devices (e.g., WiFi or Ethernet cards), graphics processors, other computing devices, etc.

In many computing systems, the host device is supported by a printed circuit board. The end devices are connected to the host devices via traces on the printed circuit board. As the traces are fixed on the printed circuit board, such connections are limited in terms of flexibility.

In some cases, the host device and the end devices are connected using cables to allow high-speed data communication. The cables connect input/output (I/O) ports associated with the host device to different end devices. As used herein, the terminology “input/output (I/O) port” refers to a socket including terminals into which one end of a cable is inserted. The I/O port, in turn, is connected to the host device via an suitable connection, such as an electrical contact or bus. The cable includes an I/O port connector at one end to connect the cable to the I/O port and an end device interface connector at the other end to connect the cable to an end device interface. As used herein, the terminology “end device interface” refers to hardware, such as an I/O slot, a backplane, or an I/O port connector into which the cable is inserted. The end device interface, in turn, is connected to the end device via any suitable connection, such as an electrical contact or bus.

Many computing systems use different I/O ports that are respectively dedicated to the different end device interfaces associated with the different types of end devices to allow the host device to communicate with the different types of end devices. The computing systems switch between the different I/O ports to allow the host device to communicate with the different types of end devices. Using dedicated I/O ports and a switch to switch between the different I/O ports requires space on the motherboard and adds to the cost of the computing system.

To mitigate at least some of these issues, according to one or more examples disclosed herein, a host device is allowed to communicate with different types of end devices associated with different protocols using a single programmable I/O port. Based on a type of an end device that is connected to the host device, the I/O port is directed to present signals that correspond to a protocol associated with the end device. Rather than switching between I/O ports, the I/O port is programmed as appropriate to allow the host device to communicate with the end device using the protocol that is associated with the end device.

According to some examples, a system to manage communication between a host device and an end device is provided. The system includes a programmable input/output (“I/O”) port associated with the host device. The host device is connectable to a plurality of different types of end devices through a cable and the programmable I/O port. The plurality of different types of end devices are respectively associated with different types of protocols. The system further includes a port manager to detect a signal from an end device interface associated with the end device and determine, based on the detected signal, a type of the end device. The port manager is further to direct the programmable I/O port to present signals that correspond to a protocol associated with the determined type of the end device to allow the host device to communicate with the end device.

According to other examples, a method to manage communication between a host device and an end device is provided. The host device is connectable to a plurality of different types of end devices through a cable and a programmable I/O port. The plurality of different types of end devices are respectively associated with different types of protocols. A signal is detected from an end device interface associated with the end device. A type of the end device is determined based on the detected signal. The programmable I/O port is directed to present signals that correspond to a protocol associated with the determined type of the end device to allow the host device to communicate with the end device.

According to other examples, a non-transitory computer readable storage medium includes computer executable instructions stored thereon that, when executed by a processor, cause the processor to manage communication between a host device and an end device. The host device is connectable to a plurality of different types of end devices through a cable and a programmable I/O port. The plurality of different types of end devices are respectively associated with different types of protocols. When executed, the instructions cause the processor to detect a signal from an end device interface associated with the end device. The instructions further cause the processor to determine, based on the detected signal, a type of the end device, and direct the programmable I/O port to present signals that correspond to a protocol associated with the determined type of the end device to allow the host device to communicate with the end device.

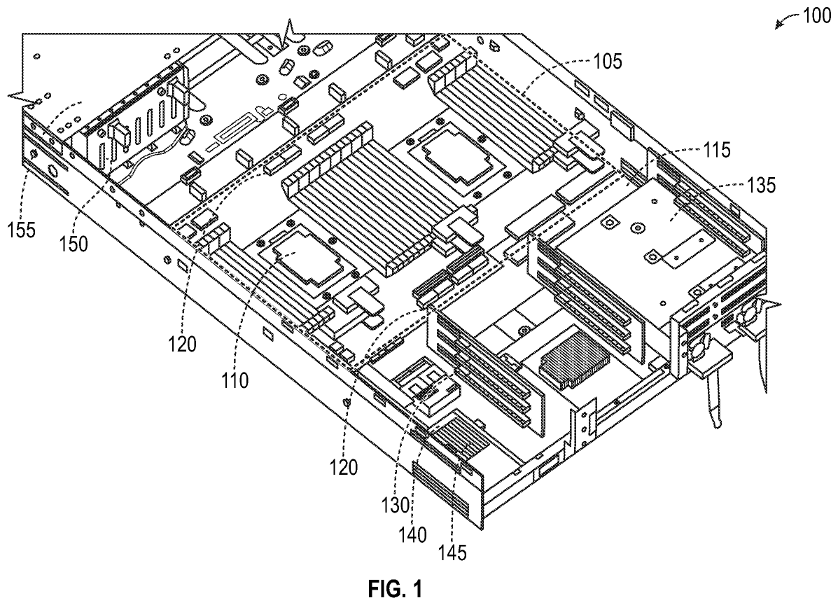

FIG. 1 is a perspective view of an assembly including host devices and end devices according to one or more examples. In the example shown in FIG. 1, the assembly 100 includes one or more host devices 110 supported by a compute portion 105 of a motherboard referred to as a “compute printed circuit board (“PCB”)”. The assembly also includes one or more programmable I/O ports 120 associated with the host devices 110.

The assembly 100 also includes a plurality of different types of end device interfaces 130, 140, and 150 supported by the motherboards. The end device interfaces are respectively associated with a plurality of different types of end devices 135, 145, and 155 that may be supported by or connected to the motherboard. In the example shown in FIG. 1, the end device interface 130 is a Peripheral Component Interconnect (“PCIe”) slot associated with an end device 135, such as a graphics processor. The end device interface 140 is an Open Compute Project (“OCP”) Network Interface Card (“NIC”) slot associated with an end device 145, such as an Ethernet or Wifi card. The end device interface 150 is a Non-volatile Memory Express Backplane (“NVME BP”) associated with an end device 155 that may include a storage device. It should be appreciated that there may be other types of end device interfaces to connect to other types of end devices.

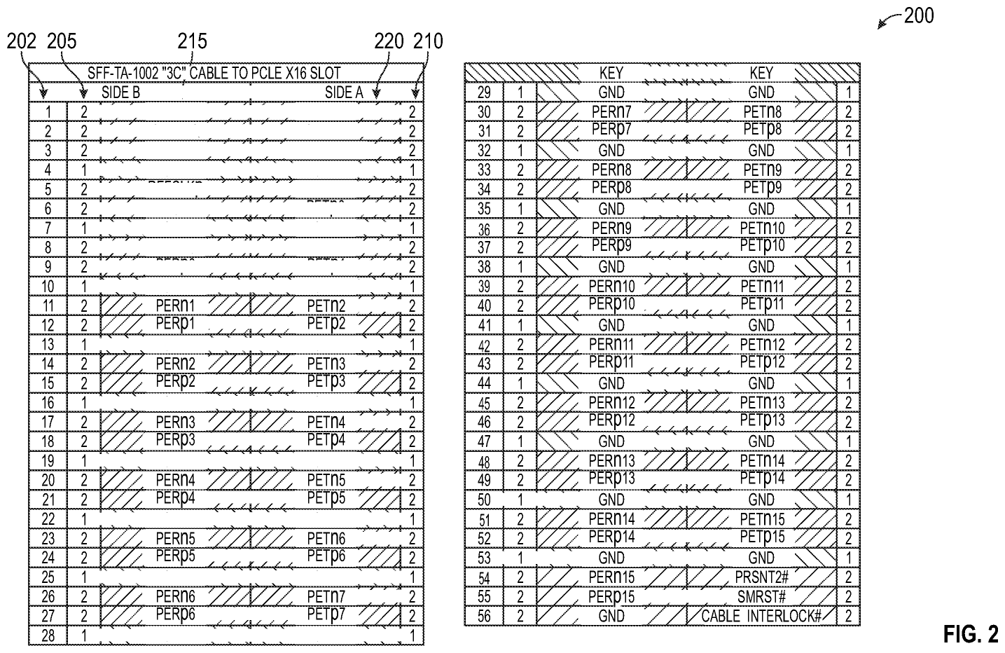

The host device 110 is connectable to the plurality of different types of end devices 135, 145, 155 via cables (not shown), the programmable I/O ports 120, and the end device interfaces 130, 140, and 150, respectively. This is described in further detail below with reference to FIGS. 2-6C.

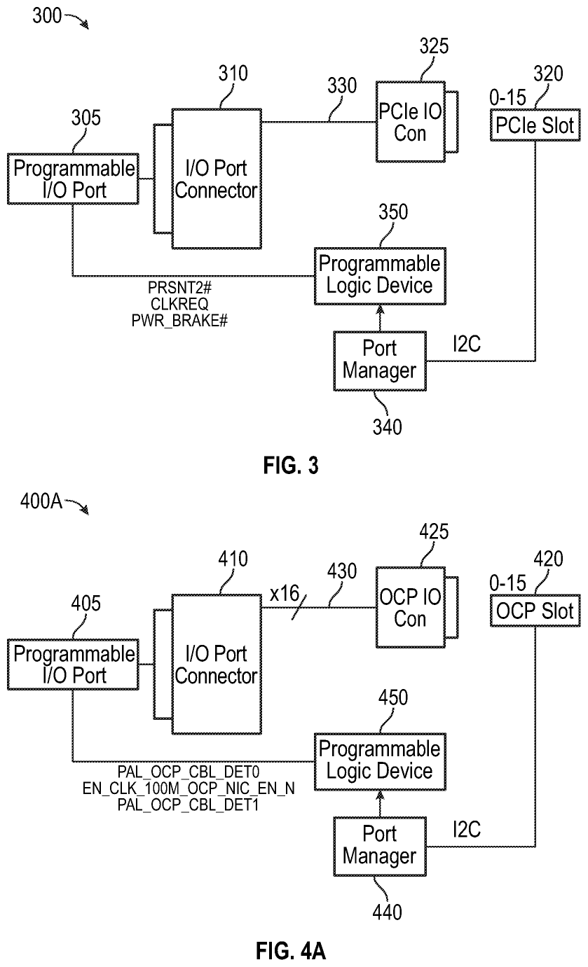

The assembly 100 also includes a system management portion 115 of a motherboard, referred to as a “management PCB”. The system management portion 115 may support management devices, such as a programmable logic device and a port manager (not shown) for managing communication between the host devices 110 and the end devices 135, 145, and 155. A programmable logic device and a port manager are described in further detail below with reference to FIGS. 3-6C.

Referring now FIG. 2, with continued reference to FIG. 1, to details of a cable connecting the programmable I/O ports 120 to the end device interfaces, FIG. 2 is a pinout 200 of a cable connecting the programmable I/O ports, such as the programmable I/O ports 120 shown in FIG. 1, to end device interfaces, such as the end device interfaces 130, 140, and 150 shown in FIG. 1. Each of the programmable I/O ports 120 includes a socket to receive a cable to connect the programmable I/O port 120 to an end device interface. According to one example, the programmable I/O port 120 includes programmable terminals, also referred to as “pins”. The terminals are “programmable” in the sense that they may present different signals based on instructions from a programmable logic devices, as described in further detail below. The pinout 200 shown in FIG. 2 is an example of signals that may be presented by the terminals of a programmable I/O port to an I/O port connector on an end of a cable (not shown) as described in more detail with reference to FIGS. 3-6C.

In FIG. 2, column 202 indicates a terminal on the programmable I/O port 120 which presents a signal, columns 205 and 210 indicate a contact sequence of the terminals indicating the ordering of terminals making contact with an I/O port connector at the end of the cable, column 215 indicates a signal presented by the programmable I/O port 120 to a side B of the I/O port connector at the end of the cable, and column 220 indicates a signal presented by the programmable I/O port 120 to a side A of the I/O port connector at the end of the cable.

In the example shown in FIG. 2, the pinout 200 is for a Small Form Factor (SFF) cable, such as a standard SFF-TA-1002 3C cable with signals to be presented to a PCIe x16 slot. It should be appreciated that this pinout is provided for illustrative purposes, and that other pinouts for other types of cables may be used.

According to some examples, the signals presented by the programmable I/O port according to this pinout may be considered default signals that are presented if no signal is detected from an end device interface other than a PCIe slot. However, in the event that a signal is detected from another type of end device interface other than a PCIe slot, terminals of the programmable I/O port, such as the programmable I/O port 120 shown in FIG. 1, are programmable to present signals that correspond to a protocol associated with the end device with which the detected signal is associated. This may be understood with reference to FIGS. 3-5 as described below.

FIG. 3 conceptually illustrates a system 300 for managing communication between a host device and an end device via a PCIe slot according to one or more examples. The system 300 includes a programmable I/O port 305.

Referring to FIG. 3, the programmable I/O port 305 is associated with a host device (not shown), such as the host device 110 shown in FIG. 1. The system 300 includes an end device interface 320 associated with an end device (also not shown), such as the end device 135 shown in FIG. 1. The system 300 also includes a cable 330 to connect the end device interface 320 and the programmable I/O port 305. The cable 330 includes an I/O port connector 310 at one end to connect to the programmable I/O port 305 and an end device interface connector 325 at the other end to connect to the end device interface 320.

The system 300 also includes a port manager 340 to detect a signal from the end device interface 320 via an inter-integrated circuit (“I2C” or “I²C” cable). The port manager 340 may determine, based on the detected signal, a type of the end device.

In some examples, the port manager 340 may have motherboard specification data stored in a memory that specifies what types of end device interfaces are installed on the motherboard and where those end device interfaces are installed. When a signal is detected from an end device interface, the port manager 340 uses the stored specification data to determine the type of end device that is connected. For example, when a signal is detected from a PCIe slot, the port manager 340 determines, based on the specification data, that the detected signal is from a PCIe slot and that the type of the end device is a PCIe device. The port manager 340 directs the programmable I/O port 305 port to present signals that correspond to a protocol associated with the determined type of the end device to allow the host device to communicate with the end device via the cable 330 and the end device interface 320.

The programmable I/O port 305 includes programmable terminals to present signals to the cable 330 via the I/O port connector 310. The programmable terminals are programmed by a programmable logic device 350 included in the system 300. The port manager 340 is to instruct the programmable logic device 350 to program the programmable terminals of the programmable I/O port 305 to present the signals to the I/O port connector 310 that correspond to the protocol associated with the determined type of the end device.

According to one or more examples, the port manager 340 instructs the programmable logic device 350 to program the programmable terminals (not otherwise shown) of the programmable I/O port 305 by providing an instruction that corresponds to a case statement in the programmable logic device 350. The case statements may define how the programmable logic device 350 programs the programmable I/O port 305. For example, if the port manager 340 provides an instruction “00”, the programmable logic device 350 programs the programmable terminals of the programmable I/O port 305 to present a first set of signals. On the other hand, if the port manager 340 provides an instruction “01”, the programmable logic device 350 programs the programmable terminals of the programmable I/O port 305 to present a different set of signals. The programmable logic device 350 “programs” the programmable terminals of the programmable I/O port by causing the terminals to output the signals that correspond to the protocol associated with the determined type of the end device.

In the example system 300 shown in FIG. 3, the end device interface 320 is a PCIe slot, and the end device interface connector 325 is a PCIe I/O Connector. For illustrative purposes, the port manager 340 is shown as instructing the programmable logic device 350 to send the signals “PRSNT2#”, “CLKREQ” and “PWR_BRAKE#” to the programmable I/O port 305 to program the programmable I/O port 305 to present these signals. Presuming that the PCIe slot is a “default” end device interface for which the I/O port is already programmed to present signals via the cable 330, the port manager 340 may not instruct the programmable logic device 350 to program the programmable I/O port to present signals. That is, for the default case of a PCIe slot, the programmable I/O port 305 would present signals PRSNT2#”, “CLKREQ” and “PWR_BRAKE#” on terminal 54 Side A, terminal 2 Side B, and terminal Side A, respectively, without being programmed by the programmable logic device 350.

In the example system 300 shown in FIG. 3, the cable 330 is a 16 lane (x16) cable. However, it should be appreciated that dual 8 lane (x8) cables may be used instead.

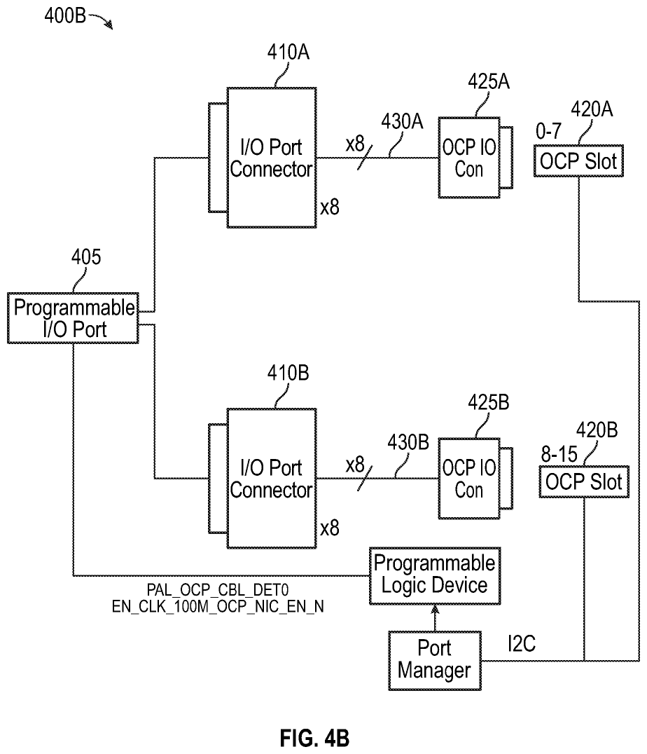

FIG. 4A conceptually illustrates a system 400A for managing communication between a host device and an end device via an OCP NIC slot according to one more examples. The system 400A include a programmable I/O port 405. The programmable I/O port 405 is associated with a host device (not shown), such as the host device 110 shown in FIG. 1. The system 400A includes an end device interface 420 associated with an end device (also not shown), such as the end device 145 shown in FIG. 1. The system 400 also includes a cable 430 to connect the end device interface 420 and the programmable I/O port 405. The cable 430 includes an I/O port connector 410 at one end to connect to the programmable I/O port 405 and an end device interface connector 425 at the other end to connect to the end device interface 420.

The system 400A also includes a port manager 440 connected to the end device interface 420 via an I2C cable. The port manager 440 is to detect a signal from the end device interface 420 and determine, based on the detected signal, a type of the end device. The port manager 440 directs the programmable I/O port 405 to present signals that correspond to a protocol associated with the determined type of the end device to allow the host device to communicate with the end device via the cable 430 and the end device interface 420.

The programmable I/O port 405 includes programmable terminals (not otherwise shown) to present signals to the cable 430 via the I/O port connector 410. The programmable terminals are programmed by a programmable logic device 450 included in the system 400A. The port manager 440 is to instruct the programmable logic device 450 to program the programmable terminals of the programmable I/O port 405 to present the signals to the I/O port connector 410 that correspond to the protocol associated with the determined type of the end device.

In the example system 400A shown in FIG. 4A, the end device interface 420 is an OCP slot, and the end device interface connector 425 is an OCP I/O Connector. As this is not the default case, the port manager 440 instructs the programmable logic device 450 to send the signals “PALOCP_CBL_DETO”. “EN_CLK_100M_OCP_NIC_EN_N”, and “PAL_OCP_CBL_DET1” to the programmable I/O port 405 to program the programmable I/O port 405 to present these signals. Accordingly, the programmable I/O port 405 presents signals “PALOCP_CBL_DETO”, “EN_CLK_100M_OCP_NIC_EN_N”, and “PAL_OCP_CBL_DET1” on terminal 54 Side A, terminal 2 Side B, and terminal 3 Side A, respectively.

In the example system 400A shown in FIG. 4A, the end device interface 420 is a dual OCP slot that is connected to a programmable I/O port 405 via a 16 lane (x16) cable 430. In another system 400B shown in FIG. 4B, respective end device interfaces 420A and 420B are OCP slots that are connected to the programmable I/O port 405 via respective 8 lane (x8) cables 430A and 430B. To determine whether to use a x16 cable connection or x8 cable connections, cable loop back detection may be performed. That is, a signal “PAL_OCP_CBL_DET” may be sent to from the programmable I/O port 405 to the end device interface 420 shown in FIG. 4A. If both “PAL_OCP_CBL_DETO” and “PAL_OCP_CBL_DET1” are detected by the programmable I/O port 405 from the cable loop back, then the host device associated with the programmable I/O port 405 may determine to use the system 400A in FIG. 4A. If the signal “PAL_OCP_CB:_DETO” is detected by and the signal “PAL_OCP_CBL_DET1” is not detected by the programmable I/O port 405, the host device associated with the programmable port I/O port may determine to use the system in FIG. 4B.

The system 400B shown in FIG. 4B includes dual programmable I/O ports 405A and 405B that are associated with a host device (not shown), such as the host device 110 shown in FIG. 1. The system 400B also includes respective end device interfaces 420A and 420B that are associated with an end device (also not shown), such as the end device 145 shown in FIG. 1. The system 400B also include respective cables 430A and 430B to connect the end device interfaces 420A and 420B to the programmable I/O ports 405A and 405B. The cables 430A and 430B include respective I/O port connectors 410A and 410B at one end to connect to the programmable I/O ports 405A and 405B and respective end device interface connectors 425A and 425B at the other end to connect to the end device interfaces 420A and 420B.

Like the system 400A shown in FIG. 4A, the system 400B also includes a port manager 440 connected to the end device interfaces by I2C cables. The port manager 440 is to detect signals from the end device interfaces 420A and 420B and determine, based on the detected signals, a type of the end device. The port manager 440 is to direct the programmable I/O ports 405A and 405B to present signals that correspond to a protocol associated with the determined type of the end device to allow the host device to communicate with the end device via the cables 430A and the end device interfaces 420A and 420B.

The programmable I/O ports 405A and 405B include programmable terminals to present signals to the respective cables 430A and 430B via the respective I/O port connectors 410A and 410B. The programmable terminals are programmed by a programmable logic device 450 included in the system 400B. The port manager 440 is to instruct the programmable logic device 450 to program the programmable terminals of the programmable I/O ports 405A and 405B to present the signals to the respective I/O port connectors 410A and 410B that correspond to the protocol associated with the determined type of the end device with which the end device interfaces 420A and 420B are associated.

In the example system 400B shown in FIG. 4B, the end device interfaces 420A and 420B are OCP slots, and the end device interface connectors 425A and 425B are OCP I/O connectors. As this is not the default case, the port manager 440 instructs the programmable logic device 450 to send the signals “PAL_OCP_CBL_DETO” and “EN_CLK_100M_OCP_NIC_EN_N” to the programmable I/O ports 405A and 405B to program the programmable I/O ports 405A and 405B to present these signals. Accordingly, the programmable I/O ports 405A and 405B present the signals “PAL_OCP_CBL_DETO” and “EN_CLK_100M_OCP_NIC_EN_N” on terminal 54 Side A, and terminal 2 Side B, respectively.

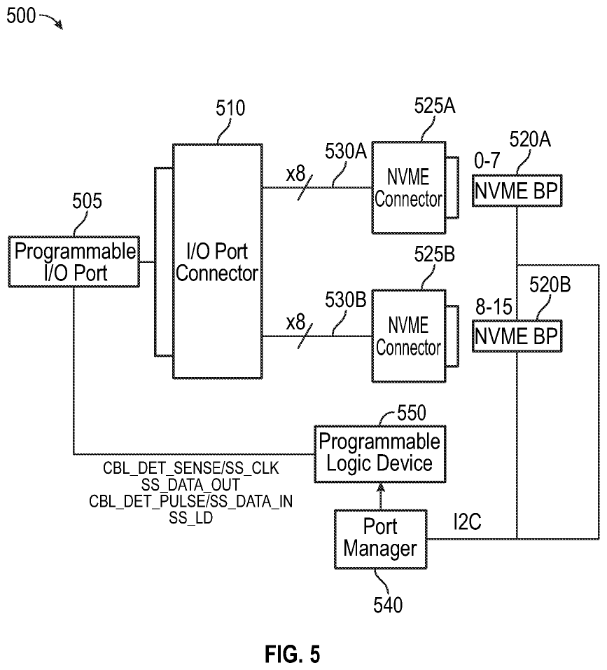

FIG. 5 conceptually illustrates a system 500 for managing communication between a host device (not shown) and an end device (also not shown) via a NVMe BP according to one more examples. The system 500 shown in FIG. 5 includes a programmable I/O port 505 that is associated with a host device, such as the host device 110 shown in FIG. 1. The system 500 also includes respective end device interfaces 520A and 520B, both of are associated with an end device, such as the end device 155 shown in FIG. 1. The system 500 also include respective cables 530A and 530B to connect the end device interfaces 520A and 520B to the programmable I/O port 505. The cables 530A and 530B are connected at one end to an I/O port connector 510 to, in turn, connect to the programmable I/O port 505. The cables 530A and 530B include respective end device interface connectors 525A and 525B at the other end to connect to the end device interfaces 520A and 520B. In the example system shown in FIG. 5, the cables 530A and 530B may be x8 cables.

The system 500 also includes a port manager 540 connected to the end device interfaces 520A and 520B via I2C cables. The port manager 540 is to detect signals from the end device interfaces 520A and 520B and determine, based on the detected signals, a type of the end device. Based on the determined type of the end device, the port manager 540 is to direct the programmable I/O port 505 to present signals that correspond to a protocol associated with the determined type of the end device to allow the host device to communicate with the end device via the cables 530A and 530B and the end device interface 520A and 520B.

The programmable I/O port 505 includes programmable terminals to present signals to the respective cables 530A and 530B via the I/O port connector 510. The programmable terminals are programmed by a programmable logic device 550 included in the system 500. The port manager 540 is to instruct the programmable logic device 550 to program the programmable terminals of the programmable I/O port 505 to present the signals to the I/O port connector 510 that correspond to the protocol associated with the determined type of the end device with which the end device interfaces 520A and 520B are associated.

In the example system 500 shown in FIG. 5, the end device interfaces 520A and 520B are NVME backplanes, and the end device interface connectors 525A and 525B are NVME Connectors. As this is not the default case, the port manager 540 instructs the programmable logic device 550 to send the signals “CBL_DET_SENSE/SS_CLK”, “SS_DATA_OUT”, “CBL_DET_PULSE/SS_DATA_IN” and “SS LD” to the programmable I/O port 505 to program the programmable I/O port 505 to present these signals. Accordingly, the programmable I/O port 505 presents signals “CBL_DET_SENSE/SS_CLK”, “SS_DATA_OUT”, “CBL_DET_PULSE/SS_DATA_IN” and “SS_LD” on terminal 3 Side A, terminal 2 Side A, terminal 54 Side A, and terminal 55 Side A, respectively.

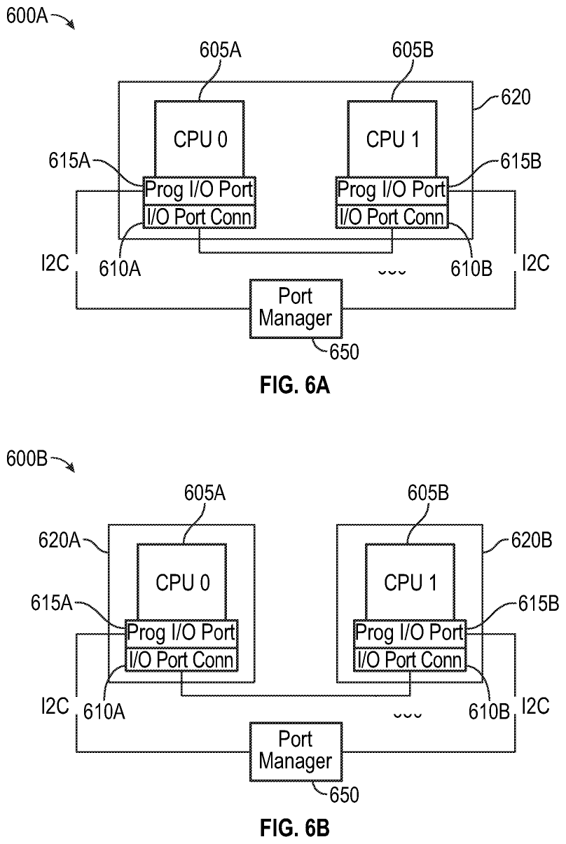

FIGS. 6A-6C conceptually illustrate systems for managing communication between a host device and one or more respective end devices via one or more cables acting as interprocessor links according to one or more examples.

Referring first to FIG. 6A, a system 600A includes a programmable I/O port 615A that is associated with a host device, e.g., the central processing unit (CPU) 605A. The system 600A also includes an end device interface, which in this example is another programmable I/O port 615B. The end device interface is associated with an end device, e.g., the CPU 605B. The system 600A also includes a cable 630 to connect the end device interface, e.g., the programmable I/O port 615B, to the programmable I/O port 615A. The cable 630 is connected at one end to the programmable I/O port 615A via an I/O port connector 610A. The cable 630 is connected at the other end to the end device interface, e.g., the programmable I/O port 615B, via another I/O port connector 610B.

The system 600A also includes a port manager 650 connected to the programmable I/O port 615B and the programmable I/O port 615A by an I2C cable. Similar to the port managers 340, 440, and 540 illustrated respectively in FIG. 3, FIGS. 4A-4B, and FIG. 5 and described above, the port manager 650 determines a type of the end device. That is, the port manager 650 detects that the end device is a CPU 605B, e.g., by detecting a signal from the end device interface, which in this example is the programmable I/O port 615B.

Based on determining that the end device is a CPU 605B, the port manager 650 directs the programmable I/O port 615A to present signals that correspond to the CPU native protocol. The programmable I/O port 615A may use some terminals (not otherwise shown) to present signals in the CPU native protocol. The signals presented on these terminals would be the same for communicating with any type of respective end device. Those terminals that are used to present signals to other types of end devices that may be programmed depending on the type of the end device are not used. Accordingly, there is no programming of the terminals of the programmable I/O port 615A by a programmable logic control device in this example.

In the example system 600A shown in FIG. 6A, the host device and the end device, e.g., the CPUs 605A and 605B, the programmable I/O port 615A, and the end device interface, e.g., the programmable I/O port 615B, are supported on the same printed circuit board 620. According to another example system 600B shown in FIG. 6B, the host device, e.g., the CPU 605A, and the programmable I/O port 615A are supported by one printed circuit board 620A. The end device, e.g., the CPU 605B, and the end device interface, e.g., the programmable I/O port 615B, are supported by another printed circuit board 620B.

Referring to FIG. 6B, the system 600B also includes a cable 630 to connect the end device interface, e.g., the programmable I/O port 615B, to the programmable I/O port 615A. The cable 630 is connected at one end to the programmable I/O port 615A via an I/O port connector 610A. The cable 630 is connected at the other end to the end device interface, e.g., the programmable I/O port 615B, via another I/O port connector 610B.

The system 600B also includes a port manager 650 connected to the programmable I/O port 615B and the programmable I/O port 615A by an I2C cable. The port manager 650 is to detect that the end device is a CPU 605B, e.g., by detecting a signal from the programmable I/O port 615B. Based on determining that the end device is a CPU, the port manager 650 directs the programmable I/O port 615A to present signals that correspond to the CPU native protocol. As in the example described above with reference to FIG. 6A, there is no programming of the terminals of the programmable I/O port 615A by a programmable logic control device in this example.

FIG. 6C illustrates a system 600C that is similar to the systems 600A and 600B. As shown in FIG. 6C, the system 600C includes a programmable I/O port 615A that is associated with a host device, e.g., the CPU 605A. The system 600C also includes respective end device interfaces, which in this example are programmable I/O ports 6156, 615C, and 615D. The end device interfaces, e.g., the programmable I/O ports 615B, 615C, and 615D, are associated with respective end devices, e.g., the CPUs 605B, 605C and 605D, respectively.

In the example system 600C, the host device and one respective end device, e.g., the CPUs 605A and 605B, the programmable I/O port 615A, and one respective end device interface, e.g., the programmable I/O port 615B, are supported on the same printed circuit board 620A. The other respective end devices, e.g., the CPUs 605C and 605D, and the other respective end device interfaces, e.g., the programmable I/O ports 615C and 615D, are supported on another printed circuit board 620B.

The system 600C also includes a cable 630A to connect the end device interface, e.g., the programmable I/O port 615B, to the programmable I/O port 615A. The cable 630 is connected at one end to the programmable I/O port 615A via an I/O port connector 610A. The cable 630A is connected at the other end to the end device interface, e.g., the programmable I/O port 6156, via another I/O port connector 6106.

The system 600C also includes another cable 630B to connect the end device interfaces, e.g., the programmable I/O ports 615C and 615D. The cable 630B is connected at one end to the end device interface, e.g., the programmable I/O port 615C via an I/O port connector 610C. The cable 630B is connected at the other end to the end device interface, e.g., the programmable I/O port 615D, via another I/O port connector 610D. As shown in FIG. 6C, the cables 630A and 630B are also interconnected to provide communication between the host device, e.g., the CPU 605A, and the end devices, e.g., the CPUs 605B, 605C, and 605D via the programmable I/O port 615A.

The system 600C also includes a port manager 650 connected to the end device interfaces, e.g., the programmable I/O ports 615B, 615C, and 615D, and the programmable I/O port 615A by I2C cables. The port manager 650 is to detect signals from the end device interfaces, e.g., the programmable I/O ports 615B, 615C and 615D, and determine that the end devices are CPUs 605B, 605C and 605D. Based on determining that the end devices are CPUs, the port manager 650 directs the programmable I/O port 615A to present signals that correspond to the CPU native protocol. As in the examples described above with reference to FIGS. 6A and 6B, there is no programming of the terminals of the programmable I/O port 615A by a programmable logic control device in this example.

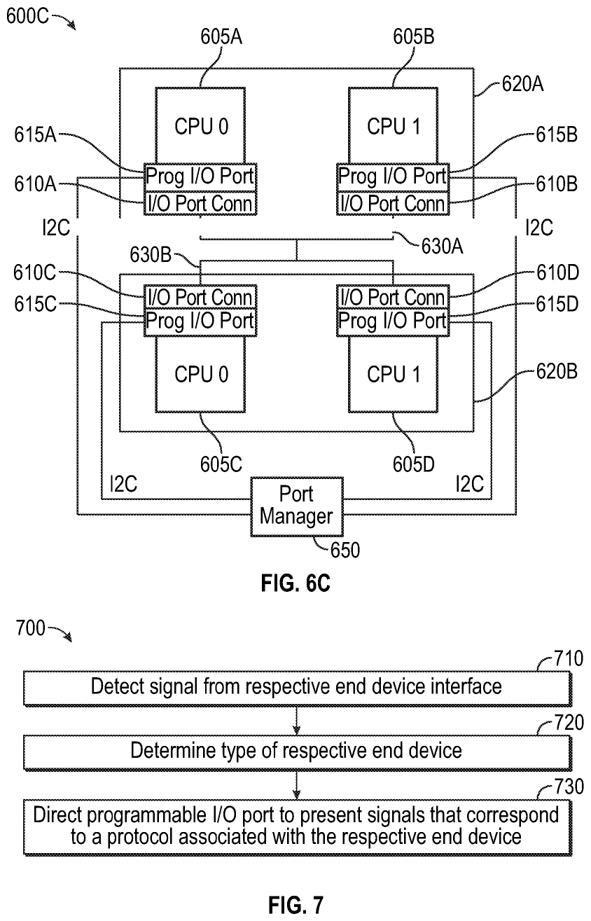

FIG. 7 is a flowchart depicting a method 700 for managing communication between a host device according to one or more examples of the disclosure. The method 700 may be performed by, for example, the port managers 340, 440, 540 and 650 shown in FIGS. 3, 4A, 4B, 5 and 6A-6C.

The method 700 includes detecting a signal from an end device interface associated with an end device at 710. The end device is connected to a host device via a cable and a programmable I/O associated with the host device. The host device is connectable to a plurality of different types of end devices, and the plurality of different types of end devices are respectively associated with different types of protocols.

Based on the detected signal, a type of the end device is determined at 720. At 730, the programmable I/O port is directed to present signals that correspond to a protocol associated with the end device based on the determined type of the end device. This may include instructing programmable logic device to program the programmable I/O port to present the signals.

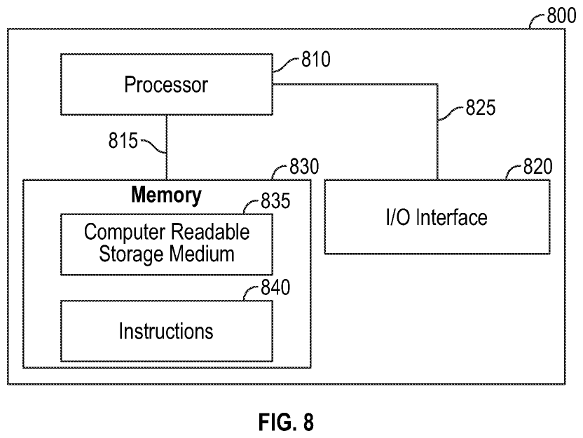

FIG. 8 is a block diagram of a computing device 800 with which the port managers 340, 440, 540 and 650 shown respectively in FIG. 3, FIGS. 4A-4B, FIG. 5, and FIGS. 6A-6C may be implemented, according to illustrative examples.

Referring to FIG. 8, the computing device 800 includes a processor 810 that is communicatively coupled to input/output (“I/O”) interfaces 820 via an address/data bus 825. The processor 810 receives inputs and transmits outputs via the I/O interfaces 820. The processor 810 can be any commercially available or custom microprocessor or microcontroller. The processor 810 may be, for instance, a controller, a microprocessor, a digital signal processor, a graphics processor, or even a processor chipset. This list is neither exclusive nor exhaustive. The I/O interfaces 820 may include any suitable connection interfaces, such as an I2C cable interface.

The processor 810 communicates with a memory 830 via, e.g., an address/data bus 815. The memory 830 is representative of a memory device containing the software and data used to implement the functionality of the computing device 800. The memory 830 can include, but is not limited to, a non-transitory computer readable storage medium 835, such as an electrically erasable programmable read-only memory (EEPROM) implemented as firmware. Still other alternatives may be used. The memory may be volatile or non-volatile, random-access or read-only, or even cache. As shown in FIG. 8, the memory 830 may include several categories of software and data used in the computing device 800, including computer executable instructions 840.

The computer executable instructions 840 can be stored in the memory 830 and can be executed by the processor 810. The computer executable instructions 840 include various programs that implement the various features of the computing device 800. For example, the computer executable instructions 840 may include instructions to implement the functions of the port manager (including detecting a signal from an end device interface associated with an end device connected to a host device via a cable and a programmable I/O port associated with the host device, determining, based on the detected signal, a type of the end device, directing the programmable I/O port to present signals that correspond to a protocol associated with the determined type of the end device based on the determined type of the end device to allow the host device to communicate with the end device, etc.).

The memory 830 may also store static and dynamic data used by the instructions 840. Also, other software programs may reside in the memory 830. The data that may be stored in the memory may include, e.g., motherboard specifications used to determine what types of end devices are connected based on signals detected from end device interfaces, instructions to send to a programmable logic device for different types of devices, etc.

It should be understood that FIG. 8 and description above are intended to provide a brief, general description of a suitable environment in which the various aspects of some examples of the present disclosure can be implemented. While the description includes a general context of executable instructions stored in firmware, the present disclosure can also be implemented in combination with other program modules and/or as a combination of hardware and software in addition to, or instead of, processor executable instructions.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A system to manage communication in a computing environment, the system comprising:
a motherboard;
a host device mounted upon the motherboard;
a plurality of end device interfaces mounted upon and sharing the motherboard, the plurality of end device interfaces being of at least two types;
a programmable input/output port associated with the host device, the host device connectable to a plurality of different types of end devices via respective ones of the plurality of end device interfaces and through the programmable input/output port and a cable, the plurality of different types of end devices respectively associated with different types of protocols; and
a port manager, the port manager configured to:
detect a signal from an end device interface associated with the end device;
determine, based on the detected signal, a type of the end device; and
direct the programmable input/output port to present signals that correspond to a protocol associated with the determined type of the end device to allow the host device to communicate with the end device.

2. The system of claim 1, wherein the programmable input/output port is to present different signals corresponding to the different protocols respectively associated with the different types of end devices.

3. The system of claim 1, wherein the programmable input/output port includes programmable terminals to present the signals.

4. The system of claim 3, further comprising a programmable logic device to program the programmable terminals to present the signals.

5. The system of claim 4, wherein the port manager is to instruct the programmable logic device to program the programmable terminals to present the signals that correspond to the protocol associated with the determined type of the end device.

6. The system of claim 1, wherein the plurality of different types of end devices are respectively associated with different types of end device interfaces including at least one of a non-volatile memory express (“NVME”) backplane, a peripheral component interconnect express (“PCIe”) slot, and an open compute project (“OCP”) slot.

7. The system of claim 1, wherein the host device includes a central processing unit (“CPU”).

8. The system of claim 7, wherein the end device includes another CPU.

9. A method to manage communication between a host device and a plurality of end devices, comprising:
detecting a signal from an end device interface associated with the end device, the end device connected to the host device via a cable and a programmable input/output port associated with the host device, the host device connectable to a plurality of different types of end devices via a plurality of end device interfaces, the plurality of different types of end devices respectively associated with different types of protocols;
determining, based on the detected signal, a type of the end device; and
directing the programmable input/output port to present signals that correspond to a protocol associated with the determined type of the end device to allow the host device to communicate with the end device,
wherein:
the host device, the end device interfaces, and the programmable input/output port are supported by a common motherboard.

10. The method of claim 9, wherein the programmable input/output port presents different signals corresponding to the different protocols respectively associated with the different types of end devices.

11. The method of claim 9, wherein the programmable input/output port includes programmable terminals to present the signals.

12. The method of claim 11, wherein directing the programmable input/output port to present signals that correspond to the protocol associated with the determined type of the end device includes instructing a programmable logic device to program the terminals to present the signals.

13. The method of claim 9, wherein the plurality of different types of devices are respectively associated with different types of end device interfaces including at least one of a non-volatile memory express (“NVME”) backplane, a peripheral component interconnect express (“PCIe”) slot, and an open compute project (“OCP”) slot.

14. The method of claim 9, wherein the host device includes a central processing unit (“CPU”).

15. (canceled)

16. A non-transitory computer readable storage medium comprising computer executable instructions stored thereon that, when executed by a processor, cause the processor to manage communication between a host device and an end device by:
detecting a signal from an end device interface associated with the end device, the end device connected to the host device via a cable and a programmable input/output port associated with the host device via respective ones of a plurality of end device interfaces, the host device connectable to a plurality of different types of end devices via a cable and a programmable input/output port associated with the host device, the plurality of different types of end devices respectively associated with different types of protocols, the host device, the plurality of end device interfaces, and the programmable input/output port being operatively coupled with and supported by a common motherboard;
determining, based on the detected signal, a type of the end device; and
directing the programmable input/output port to present signals that correspond to a protocol associated with the determined type of the end device to allow the host device to communicate with the end device.

17. The non-transitory computer readable storage medium of claim 16, wherein the programmable input/output port is to present different signals corresponding to the different protocols respectively associated with the different types of end devices.

18. The non-transitory computer readable storage medium of claim 16, wherein the programmable input/output port includes programmable terminals, and directing the programmable input/output port to present signals that correspond to the protocol associated with the determined type of the end device includes instructing a programmable logic device to program the terminals to present the signals.

19. The non-transitory computer readable storage medium of claim 16, wherein plurality of different types of devices are respectively associated with different types of end device interfaces including at least one of a non-volatile memory express (NVME) backplane. peripheral component interconnect express (PCIe) slot, and an open compute project (OCP) slot.

20. The non-transitory computer readable storage medium of claim 16, wherein the host device includes a central processing unit (CPU), and the end device includes another CPU.

21. The system of claim 1, wherein:
the programmable input/output port is to present the signals;
a programmable logic device to program the programmable terminals to present the signals, wherein the port manager is to instruct the programmable logic device to program the programmable terminals to present the signals that correspond to the protocol associated with the determined type of the end device; and
wherein the signals are presented by the programmable terminals to a port connector and are represented by a pinout in which the presented signals include a first signal that is presented by the programmable input/output port on a first side of the port connector and a second signal that is presented by the programmable input/output port on a second side of the port connector depending upon a contact sequence of the terminals with respect to the port connector.
